(19) United States
(12) Patent Application Publication
(10) Pub. No.: US 2013/0204546 A1
(43) Pub. Date: Aug. 8, 2013

(54) ON-LINE PUMP EFFICIENCY DETERMINING SYSTEM AND RELATED METHOD FOR DETERMINING PUMP EFFICIENCY

(71) Applicants: Thomas W. Devine, Cazenovia, NY (US); Alissa J. Diminich, Cazenovia, NY (US); Andrew James Weiss, Fayetteville, NY (US)

(72) Inventors: Thomas W. Devine, Cazenovia, NY (US); Alissa J. Diminich, Cazenovia, NY (US); Andrew James Weiss, Fayetteville, NY (US)

(73) Assignee: GHD Pty Ltd., Sydney (AU)

(21) Appl. No.: 13/364,533

(22) Filed: Feb. 2, 2012

(51) Int. Cl. G06F 15/00; G01F 1/00

(52) U.S. Cl. 702/45; 702/182; 702/185

(57) ABSTRACT

A system for measuring real time efficiency/performance of at least one pump in a plant or other facility includes a plurality of monitoring devices disposed in relation to said at least one pump to measure power usage, pump speed and flow characteristics of the at least one pump. A processing system is configured to receive input signals from the sensors in which the efficiency of the at least one pump can be calculated based on the sensor inputs in real-time. The processing system can also compare the calculated pump efficiency values with a user defined set point or threshold or compare to the expected pump performance.

### TECHNICAL FIELD

The subject matter disclosed herein generally relates to pumping systems and more specifically to a system and related method for providing in-situ determinations of the performance of at least one pump, for example, a reciprocating or centrifugal pump, which is provided for use in a pumping facility. In-situ performance determinations can be compared to expected characteristics of the pump, thereby enabling system operators to be proactively alerted as to declining performance of at least one pump.

### BACKGROUND

Pumping systems that are used in a range of industries, including the water, power and oil sectors, may not operate at maximum efficiency due to damaged and worn impellers, pitted volutes, bad motor windings, poor couplings and poorly commissioned pump controls, among other factors.

In most of the foregoing situations, these operating issues cannot be visibly detected and in fact may not be discovered until after the pump has already been taken out of service for scheduled maintenance, or until the problem has exacerbated to the point in which a severe or catastrophic failure has occurred.

Pumps represent a significant portion of the pumping facility energy and life cycle costs and are often critical components of a process (manufacturing or otherwise). To that end, the facility's reliability is optimal when the pumps are maintained on the basis of continuous or periodic condition monitoring. Studies have shown that 20% or more of the energy consumed by pump systems could be saved through equipment or control changes and that performance-based maintenance costs are significantly lower than calendar-based costs.

For the above-noted reasons, at a minimum, there is a palpable need to provide a real time technique for determining whether individual pumps within a facility pumping system are operating efficiently.

Attempts have previously been made to monitor pump efficiency using the so-called “thermodynamic method”, which measures heat transfer. Efficiency of pumps using this system, however, such as reciprocating and centrifugal pumps, is impractical to calculate where pumps are operating at variable speed and existing market products using this method are not configured for variable speed operation. In addition, thermodynamic based systems are unable to estimate heat transfer in non-fluid mediums such as bearings and pump casings. Therefore, the larger the pump, the more likely this type of system is going to be inaccurate.

### SUMMARY OF THE DISCLOSURE

Therefore and according to one aspect, there is provided a processing system for determining operating efficiency of at least one pump in a pumping facility, said system comprising:

at least one controller that collects characteristics of said at least one pump and having processing logic that calculates performance of said at least one pump based on said collected characteristics, said calculated performance being compared to at least one stored threshold.

In one version, the at least one threshold is a predetermined efficiency value. According to another version, the calculated real-time performance of the at least one pump is compared to stored performance curves under the same conditions.

If the compared performance is less than the desired threshold, then the operator is alerted and corrective action can be implemented. According to one version, if the performance falls below another established threshold, the at least one pump can be taken off line and/or a maintenance alert is automatically generated.

According to one version, the above processing system is incorporated into the pumping facility's existing Supervisory Control and Data Acquisition (SCADA) system.

In another version, the real-time performance characteristic values upon collection are interpreted in order to ascertain whether the signals received are valid prior to calculating performance and prior to displaying or otherwise indicating any calculated values to the operator.

In one version, actual pump efficiency is calculated by the processing system using the following relation,

$${Pump}_{eff ( a )} = \frac{Q \times H \times SpGr}{c \times {kW}_{( a )} \times {Motor}_{eff}}$$

in which Q represents the flow rate of an incompressible fluid through said pump, H represents head as the measured pressure difference between the discharge and suction sides of said at least one pump, SpGr is the specific gravity of the incompressible fluid pumped, kW(a) represents the measured power drawn by the at least one pump, Motor_{eff} represents published motor efficiency and c represents a unit conversion factor.

According to another aspect, there is provided a system for measuring efficiency of at least one pump in a pumping facility, said system comprising:

a plurality of sensors disposed in relation to said at least one pump to measure characteristics of said at least one pump; and

a processing system programmed to receive inputs from said sensors and to calculate actual performance of said at least one pump based on said measured characteristics using the hydraulic method and in which actual performance is compared to at least one stored threshold value relating to said at least one pump.

In one exemplary version, various inputs are collected from the sensors that continually monitor power usage, instantaneous pump speed and flow characteristics relating to the at least one pump. Each of the above devices are operatively connected so as to measure these pump-related parameters in real time or periodically, the inputs from each device being collected and transmitted to the processing system. In one version, the said processing system includes a programmable logic controller (PLC) that is programmed to receive each of the separate inputs from the above-noted sensors and to transmit the signals to the facility's existing SCADA system. The collected data is then analyzed and processed to determine the at least one pump's efficiency. According to one exemplary version of the system, the pump's operating point can be compared against the pump manufacturer's published pump curve. At predetermined intervals, the pump efficiency can further be trended based on historical data that has been previously collected, stored and processed.

In one exemplary version, the collected inputs are first interpreted to verify that the signals received from each of the devices are valid and that all inputs have been received prior to calculating performance and prior to displaying or otherwise indicating any calculated values or claims to the user or operator of the apparatus.

Hierarchically and if the pump's efficiency drops below a predetermined percentage according to one version, a warning alarm and maintenance work order can be automatically generated as well as a cost estimate relating to the inefficiency. Alternatively, an alert message can be generated by the SCADA system in lieu of a work order. If efficiency falls below a second predetermined percentage, the pump is automatically taken out of service and a back-up or lag pump can be brought into use.

According to another aspect, there is described a method for determining efficiency of at least one pump configured in a pumping facility, said method comprising the steps of:

measuring various operating parameters of said at least one pump;

transmitting the measured operating parameters to a processing system; and

calculating the actual efficiency of said at least one pump using the measured operating parameters.

In existing systems there may be a plurality of devices disposed in relation to said at least one pump that measure specific characteristics of said at least one pump. In these existing systems, it may be necessary to replace partially or in their entirety the plurality of existing devices with new devices with the capacity to measure and transmit observations of specific characteristics for the intent of transmission, collection and computation.

According to an exemplary embodiment, the actual pump efficiency can be determined by the processing system using the relation,

$${Pump}_{eff ( a )} = \frac{Q \times H \times SpGr}{c \times {kW}_{( a )} \times {Motor}_{eff}}$$

in which Q represents flow rate of an incompressible fluid through said pump, H represents the head as the measured pressure differential between the discharge and suction sides of said at least one pump, SpGr represents the specific gravity of the incompressible fluid pumped, kW₍ₐ₎ represents the measured power drawn by said at least one pump, Motor_{eff} represents a published motor efficiency, and c represents a unit conversion factor stored by said system.

In one version, expected pump performance is stored by the processing system and then is used in order to compare to the calculated actual efficiency.

One advantage obtained by the herein described system and method is that early and proactive determinations can be made to at least one pump disposed in a manufacturing or other processing facility or pumping station in advance of failure and thereby improving the chances for optimal performance.

The present system creates a seamless and automatic method of capturing and then analyzing the data required to identify a pump's operating efficiency within a facility by integrating existing and non-proprietary technologies with widely adopted systems (hardware and software) uniquely in order to identify pumps that operate below published performance levels.

Another advantage is that the present system can be easily retrofitted into existing facilities and pumping systems enabling a full range of pump variables to be captured in real time so as to calculate and analyze pump efficiency within a system using the hydraulic method wherein a full system of pumps of varying brands and models already in service can be suitably analyzed.

Another advantage realized by the herein described system is that determinations of decline in pump(s) performance can permit adjustments or replacements in a proactive manner, thereby maintaining overall system efficiency and performance in advance of potentially catastrophic events, as well as related improvements in cost and labor in operating these facilities.

These and other features and advantages will be readily apparent from the following Detailed Description, which should be read in conjunction with the accompanying drawings.

### BRIEF DESCRIPTION OF THE DRAWINGS

FIG. 1 illustrates a schematic diagram of a pumping system in accordance with the prior art;

FIG. 2 depicts a schematic diagram of an in-situ pump performance measuring system in accordance with an exemplary embodiment; and

FIG. 3 is a diagrammatic flow diagram of the in-situ pump performance measuring system of FIG. 2 and various processing logic operations used by the processing system to determine actual pump efficiency in accordance with one version.

### DETAILED DESCRIPTION

The following description relates to an exemplary embodiment of a system and related method used to determine pump efficiency/performance in real time. A single generic pumping system/application is described for purposes of this exemplary embodiment, but it will be readily understood that this system and related method is applicable to literally any form of pumping system in which various characteristics of a single or multiple-pump systems pumping incompressible fluid can be measured in situ and in which overall efficiencies of at least one pump of the facility can be determined in real time or periodically. However, it will be readily apparent that the herein related system and method is not limited to specific applications or fields of use. To that end, the herein described system minimally realizes applications such as potable water and waste water treatment plants within the water sector, nuclear gas and electricity plants within the power sector and oil drilling and refinery sectors.

In the course of discussion, various terms are used in order to provide a convenient frame of reference in regard to the accompanying drawings. These terms, however, should not be interpreted narrowly with regard to the novel aspects described herein, except where so specifically indicated. In addition, the accompanying drawings provided in this application are not intended to represent a scaled depiction of the present system or method, with the intended emphasis therein focusing on connectivities of related components and use of the data that is obtained therefrom.

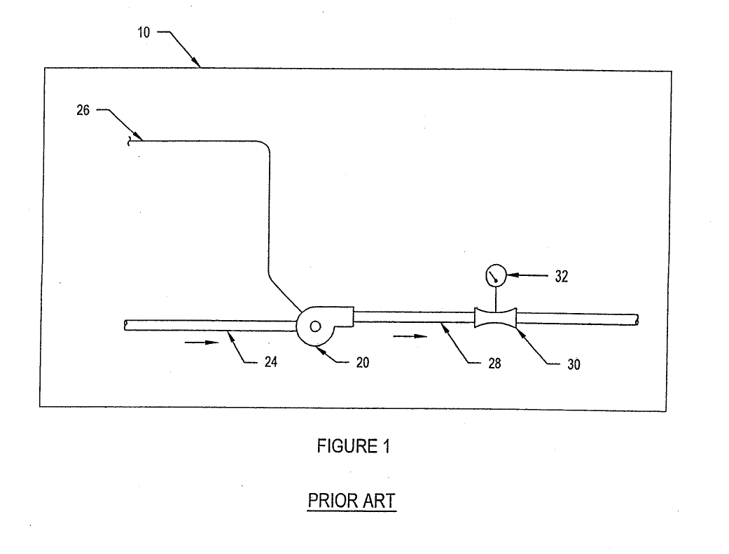

Referring to FIG. 1, there is provided a prior art representation of a pumping system, partially shown and labeled herein as 10, shown for purposes of background. The pumping system 10 includes a pump 20, such as a reciprocating or centrifugal pump, containing a pump motor (not shown) that is hydraulically connected via respective suction and discharge lines 24, 28. The pump motor is powered by an AC power source (not shown) connected through power line 26. In this system, a flow rate measuring device 30 is provided along the discharge line 28, in which the flow rate is determined and readable to a user on an attached display 32.

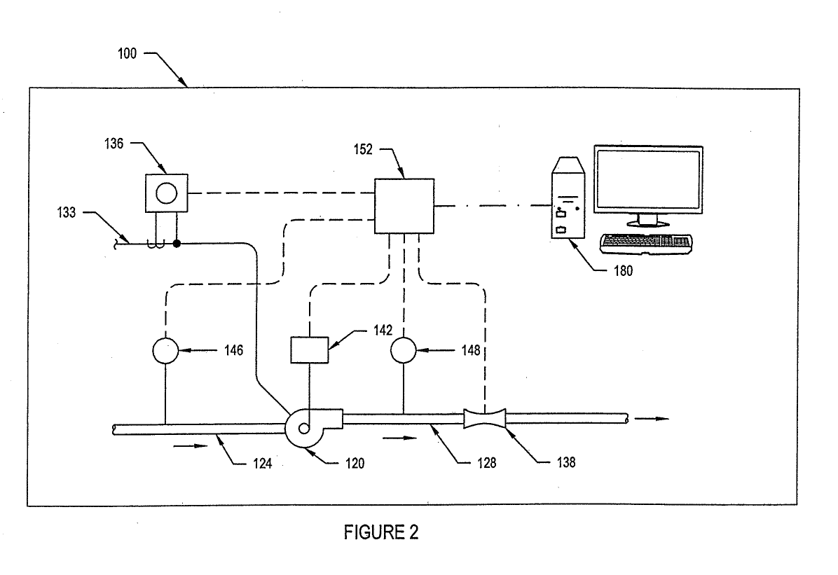

Referring to FIG. 2, there is set forth a schematic diagram of a pump as configured for operational use in a facility or plant, such as a pumping or processing station, and in which the pump is configured according to an exemplary version of the present pump efficiency/performance system. The facility, partially shown herein is identified throughout by reference numeral 100, and includes a pump 120, which is hydraulically linked in the facility by respective suction and discharge lines 124, 128. The pump 120 is a reciprocating type pump, or a centrifugal pump, defined by a housing that retains a plurality of components including a pump motor (not shown in this schematic view). The pump motor can be a fixed speed motor or a variable speed motor for purposes of this discussion. In brief, an incompressible fluid with a predetermined specific gravity, such as water, hydraulic fluid, or the like is supplied by the suction line 124 to the pump 120 and then guided through chambers disposed within the pump housing/motor, wherein the fluid is subsequently dispensed under pressure through the discharge line 128.

As opposed to current pumping systems and according to the herein described system, a plurality of sensors are operatively provided in order to continually monitor and measure specific characteristics of the pump 120. According to this exemplary embodiment, a total of five (5) sensors or measuring devices are disposed within the active circuit of the pump 120, these devices including a power meter 136 that is disposed and connected in relation to the electrical connection line 133 of the pump 120, a flow measuring device 138 disposed in the discharge line 128, a pump motor speed measuring device 142 connected to the output of the pump motor, and a pair of pressure transducers 146, 148 used to monitor the suction and discharge pressures, respectively, relative to the pump 120, the latter devices being disposed in lieu of conventional pressure gauges typically used to provide visual indications of same. In the instance that the pump 120 employs a fixed speed motor, the pump power speed device 142 could be optional.

As to the devices utilized far purposes of measuring the characteristics, the choice of device can be based on the type of pump motor. For example and if the pump motor is belt driven, the pump speed measuring device 142 could be a tachometer, a variable frequency drive (VFD) or other device capable of measuring instantaneous pump motor speed, such as a drive ratio device and transmitting an electronic signal. If the motor is shaft driven or close coupled, then a tachometer or VFD can also be used. As to the pressure measuring devices 146, 148, various devices can be used, for example, separate pressure sensors, level sensors, or a single differential pressure sensor. Alternately, manometers or other similar devices capable of providing an electronic signal output can be utilized.

Each of the above noted measuring devices 136, 138, 142, 146, 148 according to this embodiment are further connected to a processing system that includes a controller 152, such as a Programmable Logic Controller (PLC) for example those made by Allen Bradley. The monitoring devices 136, 138, 142, 146, 148 can be hard-wired to the controller 152 or can alternatively be linked by means of a suitable wireless connection, such as using IEEE 802.11 Standard, Bluetooth, Zigbee or other suitable linkage via an access point (not shown) provided in the facility 100. The controller 152 is configured with sufficient volatile and non-volatile memory for the storage of collected data, as well as a contained microprocessor (not shown). The controller 152 is programmed to receive input from each of the devices 136, 138, 142, 146 and 148 on a periodic basis for transmission to the facility's Supervisory Control and Data Acquisition (SCADA) system 180, the latter having a microprocessor programmed with sufficient logic in accordance with the present system in order to calculate pump efficiency/performance, as described herein. Though only one pump 120 is shown for purposes of this description, it will be readily apparent that a plurality of pumps can be similarly equipped as described herein for purposes of measuring each of the relevant characteristics and communicating these measured characteristics to a common or plurality of controllers.

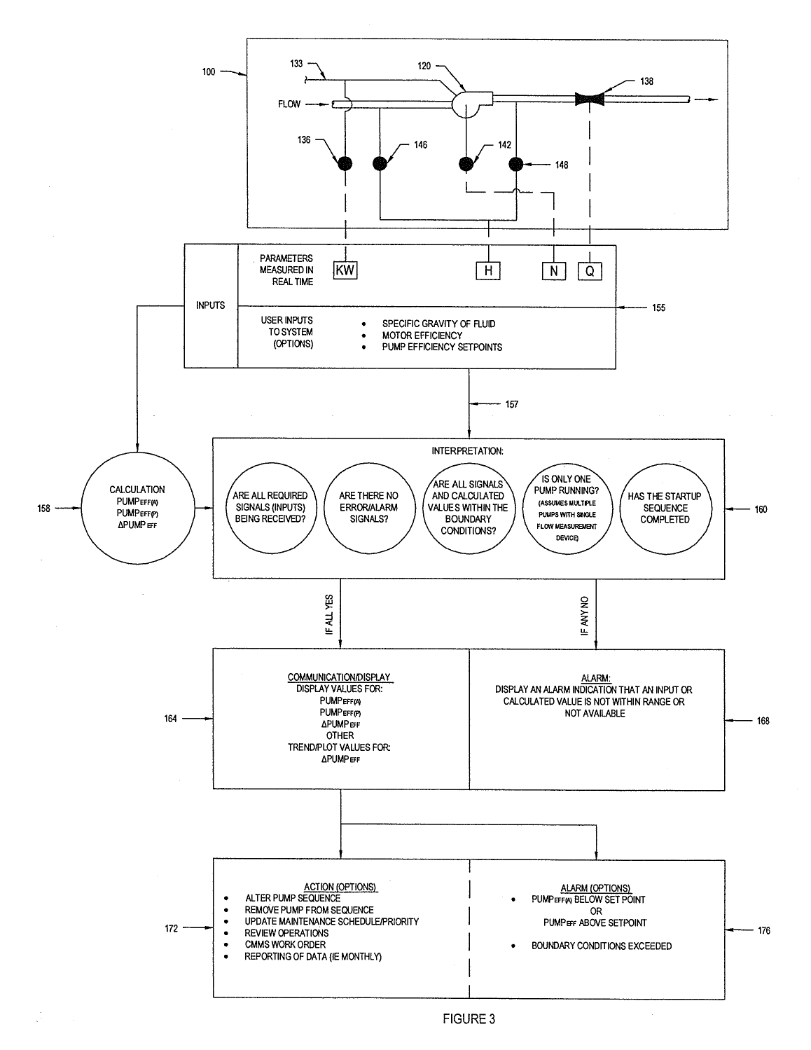

Referring to the flow diagram, FIG. 3, and according to this exemplary embodiment, the pump-related signals that are generated by the devices 136, 138, 142, 146 and 148 are transmitted or otherwise collected on a periodic or continual basis (e.g., 15-30 minutes) by the controller 152 of the processing system for calculation of the operating performance (efficiency) of the pump 120.

The pump-related parameters that are continually monitored according to this exemplary system version are Q (flow) as measured by the flow measuring device 138, H (Head or ΔP) as measured by the pressure measuring devices 146, 148, pump motor speed (N) as measured by the pump speed measuring device 142 and power consumption (kW) as measured by the power meter 136. According to this version, information is continually collected by each of the disposed devices and transmitted on a periodic basis or on demand by the controller 152 or alternatively by the SCADA system 180. As described herein, the foregoing measured data is used in conjunction with manufacturer-specific data and application-specific data that is stored by the SCADA system 180 to permit determinations of pump efficiency/performance and comparisons to expected pump performance.

For purposes of this embodiment, the manufacturer-specific data relating to the pump 120 that is entered manually into the microprocessor of the SCADA system 180 includes the published pump efficiency (Pump_{eff(p)}), the latter of which is measured as a function of pump speed, pump performance curves (head vs. flow, entered as tabular data or a polynomial function), and the pump motor efficiency (Motor_{eff}), for specific applications. As noted, application-specific data is also manually entered into the non-volatile memory of the SCADA system 180, including the specific gravity of the pumped fluid (SpGr). Optionally, other application-specific data, such as the cost of power ($/kWh) and various system curve data, can also be stored for use to be utilized in conjunction with the measured pump-related parameter data obtained from the monitoring devices 136, 138, 142, 146, 148, depending on the application,

The following presents an example of one set of relations used for determining pump efficiency/performance and the derivation thereof. This example indicates the relations using US or metric units. It will be readily apparent that other mathematical models and units could be utilized in a similar fashion. Specific parameters are identified first herein, each listed in the following Table I, as follows:

TABLE I

| | | | | Units | |
|---|---|---|---|---|---|
| Parameter Symbol | Parameter Name | Value Determination | Function of | US | Metric |
| $/kWh | Cost of Power | Provided | — | $ per kilowatt | $ per kilowatt |
| | | | | hour ($/kWh) | hour ($/kWh) |
| BHP | Brake Horsepower | Calculated | kW, Motor_{eff} | Horsepower (HP) | Horsepower (HP) |
| H | Head | Measured/Calculated | ΔP | Feet | Meters |
| Hyd_{HP} | Hydraulic Horsepower | Calculated | Q, H, SpGr | Horsepower (HP) | Horsepower (HP) |
| kW₍ₐ₎ | Kilowatts Actual | Measured/Variable | — | kilowatt (kW) | kilowatt (kW) |
| kW₍ₚ₎ | Kilowatts Published | Provided/Calculated | Q, H, kW, | kilowatt (kW) | kilowatt (kW) |
| | | | Motor_{eff}, Pump_{eff(p)} | | |
| Motor_{eff} | Motor Efficiency | User Input | — | Percent (%) | Percent (%) |
| N | Pump Speed | Measured | — | Revolutions per | Revolutions per |
| | | | | minute (rpm) | minute (rpm) |
| ΔP | Differential Pressure | Measured/Calculated | — | | |
| Pump_{eff(a)} | Pump Efficiency Actual | Calculated | Q, H, kW, | Percent (%) | Percent (%) |
| | | | Motor_{eff} | | |
| Pump_{eff(p)} | Pump Efficiency Published | Provided/Calculated | N | Percent (%) | Percent (%) |
| Q | Flow rate | Measured/Variable | — | Gallons per | Liters per |
| | | | | minute (gpm) | second (lps) |
| SpGr | Specific Gravity | User Input | — | unitless | unitless |

In terms of this exemplary embodiment, the relevant equations for purposes of determining pump efficiency/performance employing the above listed parameters are derived as follows:

### US Units

Head can either be a measured or calculated value, depending on the devices used in a given system. When pressure measuring devices are used to measure suction and discharge pressures, the differences in those values is used to calculate Head (H) by

H=k×ΔP (1)

where k is a constant used to convert ΔP into units of height of water, e.g., feet.

Hydraulic horsepower is calculated by the following relation, namely

$${Hyd}_{HP} = \frac{Q \times H \times SpGr}{3.960} \qquad ( 2 )$$

in which H is Head, as detailed above. Pump Efficiency is determined as

$${Pump}_{eff} = \frac{{Hyd}_{HP}}{BHP} \qquad ( 3 )$$

Rearranging,

$${Pump}_{eff} = \frac{Q \times H \times SpGr}{3.960 \times BHP} \qquad ( 4 )$$

Power draw is determined as

$$kW = \frac{BHP}{{Motor}_{eff}} \times 0.75 \qquad ( 5 )$$

Rearranging the foregoing equation,

$$BHP = \frac{kW \times {Motor}_{eff}}{0.75} \qquad ( 6 )$$

Therefore, including equation (6) in place of BHP shown in equation (4),

$${Pump}_{eff} = \frac{Q \times H \times SpGr}{5.280 \times kW \times {Motor}_{eff}} \qquad ( 7 )$$

Using the above relationships, actual pump efficiency can therefore be determined using measured values for Q, H and kW:

$${Pump}_{eff ( a )} = \frac{Q \times H \times SpGr}{5.280 \times {kW}_{( a )} \times {Motor}_{eff}} \qquad ( 8 )$$

Pump affinity laws are defined as

$$\begin{matrix}\frac{{BHP}_{1}}{{BHP}_{2}} = {( \frac{Q 1}{Q 2} )}^{3} = {( \frac{N 1}{N 2} )}^{3} & ( 9 ) \\ \frac{H 1}{H 2} = {( \frac{N 1}{N 2} )}^{2} & ( 10 )\end{matrix}$$

Using the above relationships, published pump efficiency can therefore be determined by referencing published pump performance curves that define the relationship between Pump_{eff(p)} and N at various flow and head conditions.

In addition, expected pump motor draw can also be determined using measured values of Q and H and published value of Pump_{eff(p)} at the actual pump speed, N:

$${kW}_{( p )} = \frac{Q \times H \times SpGr}{5.280 \times {kW}_{eff ( p )} \times {Motor}_{eff}} \qquad ( 11 )$$

In the above formulas (2) through (II) the values 3960, 0.75, and 5280 represent unit conversion factors c₁, c₂, and c₃, respectively.

### Metric Units

Head (H) can either be a measured or calculated value, depending on the devices used in a given system. When pressure measuring devices are used to measure suction and discharge pressures, the differences in those values is used to calculate Head by

H=k×ΔP (12)

where k is a constant used to convert ΔP into its of height of water, e.g., meters.

Hydraulic horsepower is calculated by the following relation, namely

$${Hyd}_{HP} = \frac{Q \times H \times SpGr}{76.1} \qquad ( 13 )$$

in which H is Head, as detailed above. Pump Efficiency as determined as

$${Pump}_{eff} = \frac{{Hyd}_{HP}}{BHP} \qquad ( 14 )$$

Rearranging,

$${Pump}_{eff} = \frac{Q \times H \times SpGr}{76.1 \times BHP} \qquad ( 15 )$$

Power draw is determined as shown above in equation (5) and repeated below,

$$kW = \frac{BHP}{{Motor}_{eff} \times 0.75} \qquad ( 5 )$$

Rearranging the foregoing equation, as shown above in equation (6) and repeated below,

$$BHP = \frac{kW \times {Motor}_{eff}}{0.75} \qquad ( 6 )$$

Therefore, including equation (6) in place of BHP shown in equation (15),

$${Pump}_{eff} = \frac{Q \times H \times SpGr}{101.5 \times kW \times {Motor}_{eff}} \qquad ( 16 )$$

Using the above relationships, actual pump efficiency can therefore be determined using measured values for Q, H and kW₍ₐ₎:

$${Pump}_{eff ( a )} = \frac{Q \times H \times SpGr}{101.5 \times {kW}_{( a )} \times {Motor}_{eff}} \qquad ( 17 )$$

Pump affinity laws are defined above in equations (9) and (10) and repeated below as,

$$\begin{matrix}\frac{{BHP}_{1}}{{BHP}_{2}} = {( \frac{Q 1}{Q 2} )}^{3} = {( \frac{N 1}{N 2} )}^{3} & ( 9 ) \\ \frac{H 1}{H 2} = {( \frac{N 1}{N 2} )}^{2} & ( 10 )\end{matrix}$$

Using the above relationships, published pump efficiency can therefore be determined by referencing published pump performance curves that define the relationship between Pump_{eff(p)} and N at various flow and head conditions.

In addition, expected pump motor draw can also be determined using measured values of Q and H and published value of Pump_{eff(p)} at the actual pump speed, N:

$${kW}_{( p )} = \frac{Q \times H \times SpGr}{101.5 \times {Pump}_{eff ( p )} \times {Motor}_{eff}} \qquad ( 18 )$$

In the above formulas (12) through (18) the values 76.1, 0.75, and 101.5 represent respective unit conversion factors c₄, c₅, and C₆.

According to the present embodiment, the SCADA system 180 is configured to calculate and display or otherwise provide an indication of the results of equations (8) and (11) or equations (17) and (18) on a periodic basis (e.g., every 15-30 minutes). It will be readily apparent that the period in which results e displayed can be easily modified depending on the application. Moreover, the monitoring devices do not necessarily require the ability to continually monitor each of the pump-related parameters, provided that measured values can be collected for transmission to the controller 152 on either a periodic basis or alternatively on demand. More specifically and in the current system, the input signal results, shown collectively as 155 in FIG. 3 are transmitted from the controller 152 to the SCADA system 180. This transmission can take place over a wired connection, or wirelessly, wherein the data can be transmitted every 15-30 minutes or other predetermined timeframe.

Prior to display, and possibly concurrently to any calculations, however and according to this exemplary embodiment, the microprocessor of the SCADA system 180 is additionally programmed to first interpret or otherwise examine the validity of the various signals that have been collected by the various sensors 136, 138, 142, 146, 148 and the values that have been calculated using the mathematical relationships noted in the foregoing discussion, specifically actual pump efficiency, published pump efficiency and the resulting difference between the actual and published efficiency values. As a result, this interpretative element of the herein described system provides a filter prior to transmitting and displaying (or otherwise indicating) the resulting efficiencies/performance. The purpose of this component of the herein described system is to identify an error in either the signal or calculations and to either display or otherwise notify the operator.

Interpretative issues for consideration according to this embodiment are noted at step 160, FIG. 3, and include the following: i) whether all input signals from each of the measuring devices 136, 138, 142, 146, 148 have been received before making the required performance calculations (i.e., has there been a loss in signal or an obvious error in the signal received), ii) whether all signals are within the anticipated boundary conditions for each collected value (reading), iii) comparative history discrepancies between signals including any relative rates of change of signals, iv) verification that no alarm/error signals, and v) that the start-up sequence of the pump has been completed. Additionally and in the instance of multiple pump systems being used in the facility 100, verification can also be made that only one pump is operating if used with a single or common flow measurement device 138.

As noted, the above-noted interpretation component of the herein described system acts as a filter prior to transmitting the calculated values to the SCADA system 180 for display or otherwise communicating useful data to the operator/user. In addition to the pump efficiency and power draw, information that can be displayed to the user/operator can further include measured or calculated values as described herein. Information anticipated to be of value to the user is shown in the communication/display step 164 of FIG. 3.

The determination of actual pump efficiency, Pump_{eff(a)} according to this exemplary embodiment is further depicted in accordance with FIG. 3 in regard to the pump 120 and pumping facility 100 previously depicted in FIG. 2, for illustrative purposes.

The first step of the process logic for this exemplary system depicted in FIG. 3 is to monitor the various pump related parameters from the various devices 136, 138, 142, 146 and 148, more specifically power kW₍ₐ₎, flow (Q), pump speed (N), suction and discharge pressure, on a periodic or continual basis as the inputs 155 to the system, along with other required and optional user inputs as depicted in 155 of FIG. 3. These user inputs include values for specific gravity of the fluid being pumped (e.g., water=1.0), and the published pump motor efficiency and published pump efficiency that are manually stored in the controller 152 or microprocessor of the SCADA system 180. Per step 155, head (H) is calculated as the difference between the readings provided by the pressure measuring devices 146, 148. Per step 157, monitored values for each of the above monitoring devices 136, 138, 142, 146, 148 are collected on a periodic basis by the processing system, and more specifically the controller 152. Per step 160, the collected values are interpreted at the controller 152 prior to transmission to the microprocessor of the SCADA system 180 prior to calculation of actual pump efficiency or the values can be interpreted at the SCADA system 180.

Actual pump efficiency can then be calculated, per step 158, using the relation set forth at (8),

$${Pump}_{eff ( a )} = \frac{Q \times H \times SpGr}{c \times {kW}_{( a )} \times {Motor}_{eff}}$$

in which the measured values for flow (Q), kW₍ₐ₎ and H (as converted to an Input 155) can be added along with the stored values for SpGr, Motor_{eff}, and c the unit conversion factor. This calculated value can then be compared, as described previously in regard to the published pump efficiency value or alternatively to a predetermined set point, which is stored by the SCADA system 180 per step 160. Alert and displays can then be provided in the manner discussed below.

The values as calculated, step 158, FIG. 3, and verified step 160, FIG. 3, by the interpretation component of the herein described system in SCADA system 180 are displayed per step 164. In addition and according to this embodiment, the SCADA system 180 is programmed to transmit various alarms/alerts depending on the results per steps 168, 176. For example, an alarm function can be automatically triggered if the value of a specific parameter (i.e., pump_{eff} or kW₍ₐ₎) has reached or exceeded the predetermined set point. A further indication is provided in terms of action that the at least one pump may require immediate or imminent attention (e.g., replacement) based on the predetermined set point. Various other action functions step 172, FIG. 3, can be generated in response to calculated values in connection with performance. For example and in multi-pump systems, the action generated by the herein-described system could include a proposed resequencing of the pumps used for purposes of optimization of various pump running sequences. For example and if the calculated actual pump efficiency drops below a first predetermined set point, then in addition to an alarm/alert, a maintenance alert is generated automatically as well as a cost estimate of the inefficiency. If the calculated efficiency drops below a second lower predetermined set point, the pump 120 is automatically taken off line and a back-up or lag pump (not shown) is introduced.

As noted, alarms and/or alerts, step 176, FIG. 3, can also be generated automatically by the herein described system based on predetermined thresholds. For example, an alarm can be generated if the calculated actual pump efficiency is below a predetermined set point or if the pump efficiency is above a first specific set point. Alternatively and/or in conjunction, an alarm is also triggered if certain predetermined boundary conditions are exceeded for any parameter as measured by the monitoring devices 136, 138, 142, 146 and 148. The alarm or alert that is automatically generated by the herein described system can include a visual and/or audible indicator that is provided to the user/operator either using the display of the SCADA system 180 or via other means, such as alarm lights, speakers, and the like provided in the pumping facility.

### PARTS LIST FOR FIGS. 1-3

10 facility
20 pump
24 suction line
26 power line
28 discharge line
30 flow measuring device
32 gauge
100 facility
120 pump
124 suction line
128 discharge line
133 electrical power line, pump
136 power meter
138 flow measuring device
142 pump motor speed measuring device
146 pressure measuring device
148 pressure measuring device
152 controller
155 measured parameters
157 transmittance step
158 calculation step
160 interpretation step
164 communication/display step
168 alarm step
172 action step
176 alarm/options step
180 SCADA system

It will be readily apparent that other modifications and variations are possible within the intended ambits described herein and according to the following claims.

1. A method for determining efficiency of at least one pump configured in a pumping facility, said method comprising the steps of:
measuring various operating parameters of said at least one pump;
transmitting the measured operating parameters to a processing system; and
calculating the actual efficiency of said at least one pump based on the measured operating parameters.

2. A method as recited in claim 1, wherein said method further includes the step of comparing the calculated efficiency of said pump to an expected efficiency of said pump under the same operating conditions and providing an alert if the compared actual efficiency deviates from the expected efficiency by a predetermined amount.

3. A method as recited in claim 1, including the step of disposing a plurality of sensors for measuring the power usage and flow characteristics of said at least one pump, wherein said sensors include means for transmitting collected signals to said processing system.

4. A method as recited in claim 3, including the step of disposing a plurality of sensors for measuring the pump speed of said at least one pump, wherein said sensors includes means for transmitting collected signals to said processing system.

5. A method as recited in claim 3, wherein said plurality of sensors are configured to periodically or continually measure and transmit said operating parameters.

6. A method as recited in claim 3, wherein said processing system includes at least one controller that receives the readings from said monitoring devices, said method including the step of transmitting said values to said at least one controller for calculating said efficiency.

7. A method as recited in claim 3, wherein said processing system includes at least one controller that receives the readings from said monitoring devices, said method including the step of transmitting said values from said at least one controller to the facility operating system for calculating said efficiency.

8. A method as recited in claim 1, including the step of displaying at least one measured or calculated value related to said at least one pump.

9. A method as recited in claim 6, including the additional step of interpreting the measured readings of said sensors and the calculated values prior to said displaying step.

10. A method as recited in claim 9, wherein said interpreting step further includes the step of determining whether potential errors exist in at least one of the collected readings of said sensors and the calculated values.

11. A method as recited in claim 10, including the additional step of indicating the potential cause of said potential errors to a user or operator.

12. A method as recited in claim 1, wherein said pumping system is a multi-pump system, said method including the additional steps of determining a change in efficiency in at least one of the pumps and indicating a revised sequence for use of said pumps based on said change.

13. A method as recited in claim 1, including the additional steps of determining the actual pump efficiency, identifying the expected pump efficiency and calculating the differences between the actual and expected pump efficiencies.

14. A method as recited in claim 13, wherein said actual pump efficiency is determined using the relation
$${Pump}_{eff ( a )} = \frac{Q \times H \times SpGr}{c \times {kW}_{( a )} \times {Motor}_{eff}}$$
in which Q represents flow rate, H (head) represents the pressure differential between the discharge and suction sides of said at least one pump. SpGr represents the specific gravity of the incompressible fluid flowing through said pump, kW₍ₐ₎ represents the power used by the pump, Motor_{eff} represents a published value of motor efficiency and c represents a unit conversion factor stored by said system

15. A method as recited in claim 13, including the steps of storing application specific and manufacturer specific data in the memory of the controller for said calculating step in conjunction with the collected pump-related data.

16. A system for measuring efficiency of aid at least one pump in a pumping facility, said system comprising:
a plurality of sensors disposed in relation to said at least one pump to measure characteristics of said at least one pump; and
at least one controller configured to periodically receive inputs from said sensors and to calculate actual performance of said at least one pump based on said measured characteristics using the hydraulic method and in which the actual performance is compared to at least one stored threshold value relating to said at least one pump.

17. A system as recited in claim 16, including means for displaying at least one measured or calculated value relating to said at least one pump.

18. A system as recited in claim 17, wherein the inputs from said sensors and the resulting calculated values are validated prior to displaying same.

19. A system as recited in claim 16, wherein an alert is triggered if the performance of the at least one pump deviates from said expected performance by a predetermined amount.

20. A system as recited in claim 19, wherein said controller is configured to store published performance curves of said at least one pump.

21. A system as recited in claim 19, wherein the possible cause of deviation from the expected performance is presented to the user.

22. A system as recited in claim 16, wherein said controller is wirelessly connected to said sensors, each of said sensors transmitting pump-related data to said controller over the wireless connection.

23. A system as recited in claim 16, wherein said plurality of sensors comprise a flow measuring device, a power usage measuring device and at least one pressure measuring device.

24. A system as recited in claim 23, wherein said plurality of sensors include a pump speed measuring device.

25. A processing system for determining operating efficiency of at east one pump in a pumping facility, said system comprising:
at least one controller that collects characteristics of said at least one pump and having processing logic that calculates performance of said at least one pump based on said collected characteristics, said calculated performance being compared to at least one stored threshold.

26. A processing system as recited in claim 25, wherein said measured characteristics include flow rate, power consumption, suction and discharge pressures and pump motor speed.

27. A processing system as recited in claim 26, wherein real-time efficiency of said at least one pump is determined by the relation
$${Pump}_{eff ( a )} = \frac{Q \times H \times SpGr}{c \times {kW}_{( a )} \times {Motor}_{eff}}$$
in which Q represents flow rate, H (head) represents the pressure differential between the discharge and suction sides of said at least one pump, SpGr represents the specific gravity of the incompressible fluid flowing through said pump, kW(a) represents the power used by the pump, Motor_{eff} represents a published value of motor efficiency and c represents a unit conversion factor stored by said processing system.

28. A processing system as recited in claim 27, wherein characteristics are collected at periodic intervals, said at least one controller including a programmable logic controller that is connected to the pumping facility's Supervisory Control and Data Acquisition (SCADA) system.

29. A processing system as recited in claim 27, including a plurality of sensors for measuring said pump-related characteristics in real time, said sensors having means for transmitting collected values to said at least one controller.
